(19) United States
(12) Patent Application Publication
(10) Pub. No.: US 2015/0099087 A1
(43) Pub. Date: Apr. 9, 2015

(54) PRINTED ENCAPSULATION

(71) Applicant: A. Raymond Et Cie, Grenoble (FR)

(72) Inventors: Jason F. Reznar, Redford, MI (US); Todd L. Hemingway, Metamora, MI (US)

(73) Assignee: A. Raymond Et Cie, Grenoble (FR)

(21) Appl. No.: 14/391,745

(22) PCT Filed: Mar. 13, 2013
(86) PCT No.: PCT/US2013/030717

§ 371 Date: Oct. 10, 2014

Related U.S. Application Data
(60) Provisional application No. 61/622,146, filed on Apr. 10, 2012.

(51) Int. Cl. B29C 47/02; B29C 67/00

(52) U.S. Cl. CPC B29C 47/02; B29C 67/0051; B29L 2009/00
USPC 428/68; 264/401

(57) ABSTRACT

A printed encapsulation method and part are provided. Another aspect uses a three-dimensional printing machine to emit material from an ink jet printing head to build up material attached to an insert.

### CROSS-REFERENCE TO RELATED APPLICATIONS

This application claims the benefit and priority of U.S. Provisional Patent Application Ser. No. 61/622,146, filed on Apr. 10, 2012, which is incorporated by reference herein.

### BACKGROUND AND SUMMARY

The present disclosure relates generally to part manufacturing and more particularly to printed encapsulation of an insert.

Traditionally, polymeric parts are made by injection or extrusion molding. In such processes, a heated polymeric liquid is inserted into match metal dies under high pressure, after which the dies are internally cooled in order to cure the manufactured parts. Air is vented from the die cavity when the molten polymer is injected therein. Injection and extrusion molding are ideally suited for high volume production where one hundred thousand or more parts per year are required. These traditional manufacturing processes, however, disadvantageously require very expensive machined steel dies, which are difficult and time consuming to modify if part revisions are desired, and are subject to problematic part-to-part tolerance variations. Such variations are due to molding shrinkage during curing, molding pressure differences, part warpage due to internal voids and external sink marks, and the like. The expense of this traditional die tooling makes lower volume production of polymeric parts prohibitively expensive.

Furthermore, insert molding is known. Traditional insert molding requires a metallic insert to be placed between the match metal dies such as on a shuttle press, the dies are closed and then the liquid polymer is injected under high pressure to surround the desired sections of the insert in the mold. Nevertheless, at least some portions of the insert must be exposed from the polymer so the insert can contact against and be held by the dies during molding. This tooling is expensive and part-to-part tolerance variation is a concern given the high pressure liquid pressing against often unsupported sections of the inserts.

In accordance with the present invention, a printed encapsulation method and part are provided. In another aspect, a part includes a prefabricated insert against which are layers of an additive polymeric material. Another aspect uses a three-dimensional printing machine to emit material from an ink jet printing head to build up material attached to an insert. A further aspect provides a method of making a part by depositing material in layers and/or a built-up arrangement attached to an insert.

The present printed encapsulation method and part are advantageous over traditional devices. For example, the present method and part do not require any unique tooling or dies, thereby saving hundreds of thousands of dollars and many weeks of die manufacturing time. Furthermore, the present method allows for quick and inexpensive design and part revisions from one manufacturing cycle to another. In another aspect, part-to-part tolerance variations are essentially non-existent with the present method and part such that at least ten, and more preferably at least forty, identical parts can be produced in a single machine manufacturing cycle. It is also noteworthy that the present method and part are advantageously capable of creating die-locked part configurations that would otherwise be expensive to produce with conventional insert molding dies. Additional advantages and features of the present invention can be found in the following description and appended claims as well as in the accompanying drawings.

### BRIEF DESCRIPTION OF THE DRAWINGS

FIG. 1 is a top elevational view showing a washer embodiment of the present invention;

FIG. 2 is a side elevational view showing the washer embodiment;

FIG. 3 is a cross-sectional view, taken along line 3-3 of FIG. 1, showing the washer embodiment;

FIG. 4 is a top elevational view showing a cap embodiment of the present invention;

FIG. 5 is a side elevational view showing the cap embodiment;

FIG. 6 is a cross-sectional view, taking along line 6-6 of FIG. 4, showing the cap embodiment;

FIG. 7 is a top elevational view showing a nut embodiment of the present invention;

FIG. 8 is a cross-sectional view, taking along line 8-8 of FIG. 7, showing the nut embodiment;

FIG. 9 is a side elevational view showing the nut embodiment;

FIG. 10 is a top elevational view showing a bezel and window embodiment of the present invention;

FIG. 11 is a cross-sectional view, taken along line 11-11 of FIG. 10, showing the bezel and window embodiment;

FIG. 12 is a top elevational view showing an electrical circuit embodiment of the present invention;

FIG. 13 is a side elevational view showing the electrical circuit embodiment;

FIG. 14 is an end elevational view, taken in the direction of arrow 14 from FIG. 12, showing the electrical circuit embodiment;

FIG. 15 is a fragmentary end elevational view, taken in the direction of arrow 15 from FIG. 12, showing the electrical circuit embodiment;

FIG. 16 is a cross-sectional view, taken along line 16-16 of FIG. 12, showing the electrical circuit embodiment;

FIG. 17 is a diagrammatic top view showing a fabric embodiment of the present invention;

FIG. 18 is a diagrammatic side view showing the fabric embodiment;

FIG. 19 is a diagrammatic cross-sectional view, taken along line 19-19 of FIG. 17, showing the textile embodiment;

FIG. 20 is a perspective view showing a machine manufacturing the washer and bezel/window embodiment parts, with an upper cover of the machine removed; and

FIGS. 21A-D are a series of diagrammatic side views showing the machine building up the washer and bezel/window embodiment parts.

### DETAILED DESCRIPTION

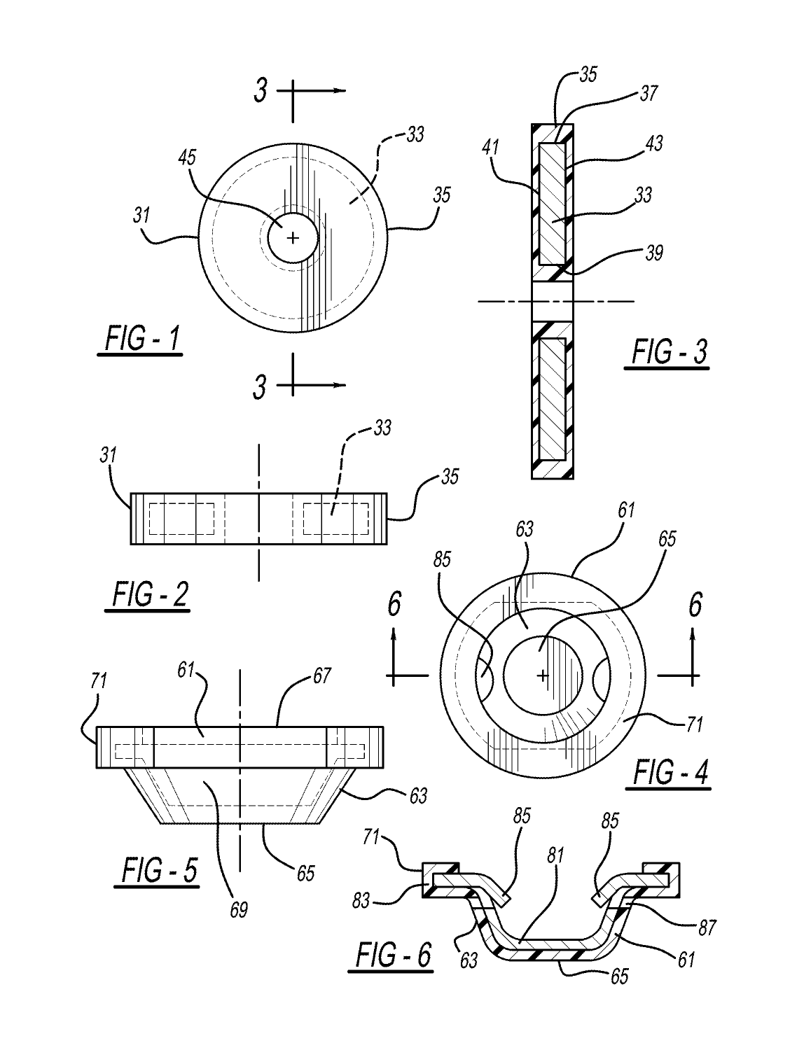

Referring to FIGS. 1-3, a print encapsulated washer part 31 includes a rigid metal insert 33 surrounded by a three-dimensionally printed polymeric cover 35. Insert 33 is a prefabricated component stamped from sheet steel and having a circular peripheral surface 37, a concentric circular inner surface 39 defining a through-hole 45, and a pair of generally flat top and bottom surfaces 41 and 43. Polymeric cover 35 has a final shape matching that of the insert 33 but with the additional thickness of the polymeric material thereupon. It should be alternately appreciated, however, that the peripheral and inner shapes of the insert and/or polymeric cover can be polygonal, have gear teeth, be eccentric or have various other shapes, although certain of the present advantages may not be realized. In one version, polymer cover 35 is at least 2 mm thick adjacent inner and peripheral surfaces 39 and 37, respectively. As used herein, “prefabricated” means manufactured prior to the polymer printing process.

The three-dimensionally printed polymeric cover 35 is preferably a DM 9840 printable material although DM 9860 or VeroWhite printable polymers may alternately be employed. Polymeric cover 35 is somewhat flexible after printing and curing, and certainly more flexible than the rigid insert located therein. Therefore, washer 31 is ideally suited to seal an aperature around a bolt, tube, wire or other member extending through central hole 45 therein. It is believed that the entire and complete polymeric encapsulation of the steel insert deters and prevents the insert from rusting after at least 1,000 hours of a salt spray test. Accordingly, washer 31 is perfectly suited for use in a marine environment such as on a boat, off-shore oil platform, dock, sea water pump, or other such use.

FIGS. 4-6 illustrate a cap part 61 which serves as an aesthetically pleasing cover of a screw or axle head extending through a wheel of a toy. Cap 61 preferably has a frusto-conically tapered sidewall 63 ending at a centrally enclosed end 65. An offset and enlarged end 67 is openly accessible and includes a receptacle cavity 69 therein. A circular flange 71 laterally extends outboard from end 67.

Cap 61 includes a cup-shaped and concave metallic insert 81 partially encapsulated by a three-dimensionally printed polymeric cover 83. Insert 81 is a prefabricated component preferably stamped from sheet steel 1050-1065, heat treated to 44-51 Rc, of 0.025 inches thickness. Inwardly extending prongs or snap fingers 85 are locally stamped inwardly from sidewalls 63 so as to flexibly secure the cap onto the mating screw or axle head of the toy. A window or void 87 is located through polymeric cover 83 and prefabricated insert 81 behind each finger 85. Such a void 87 is easily produced with the present three-dimensionally printing process even though this would otherwise create a die-lock condition requiring expensive and complicated slides in a conventional injection molding process. A high density polyethylene ASTM type 111, unfilled, polymer that can be printed or an Objets Fullcure 720 printed polymer, is employed for cover 83. It is believed that the three-dimensionally printed polymeric cover will not separate from the prefabricated metallic insert in an Instron machine tensile pull test at at least 650 pounds, and more preferably at at least 725 pounds.

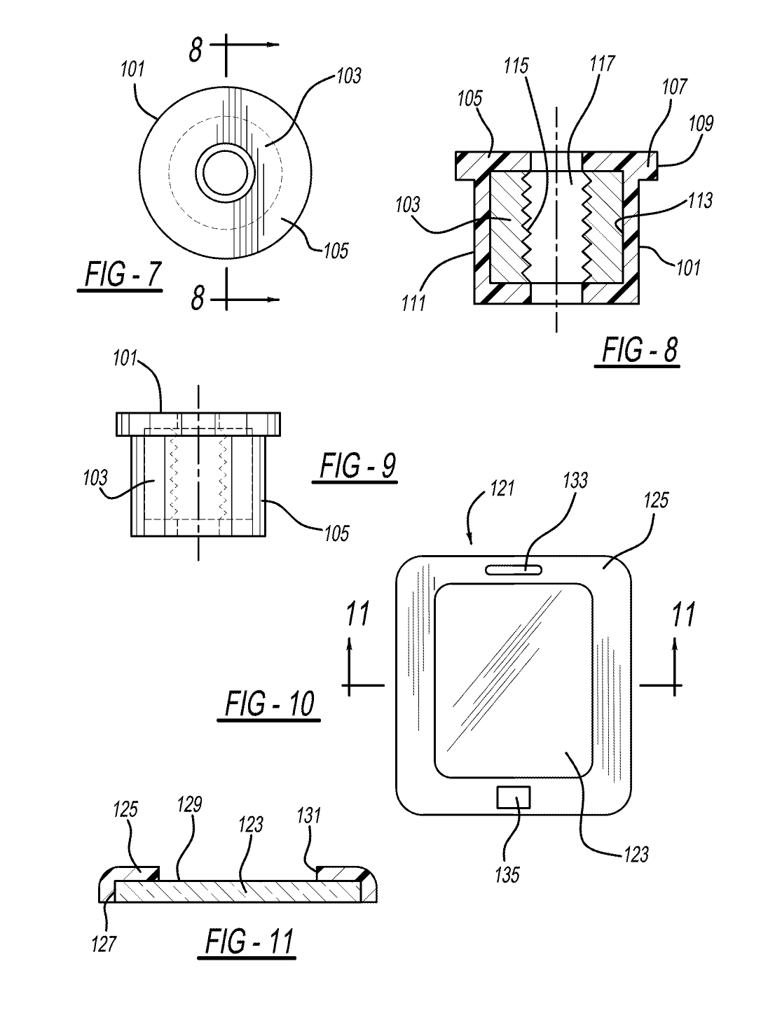

FIGS. 7-9 illustrate a nut part 101 including a prefabricated metallic insert 103 at least partially encapsulated by a three-dimensionally printed polymeric cover 105. More specifically, nut 101 is of a hat nut design including a laterally extending flange 107 having a circular peripheral surface 109, and a cylindrical periphery 111 for a body thereof. Insert 103 has a matching cylindrical periphery 113 and internal threads 115 about a through-bore 117. It is alternately envisioned that external periphery 113 of nut 103 may have a polygonal, fluted or other differently shaped surface to provide mechanical interlocking engagement with a matching internal surface of cover 105 while exterior surface 111 of cover 105 may still remain cylindrical or may be provided with a wrench-receiving generally polygonal shape. Polymeric cover 105 is preferably a Fullcure 720 printed material.

Referring now to FIGS. 10 and 11, a finished part 121 includes a transparent window insert 123 and a peripherally surrounding three-dimensionally printed polymeric bezel 125. This is ideally suited for use as a display in an electronic component such as a cellular telephone, hand-held PDA device, computer screen, television or the like. Bezel 125 extends around a peripheral edge 127 of insert 123 as well as one or both enlarged flat faces 129 thereof. A large central opening 131 is provided in bezel 125 to allow for viewing through insert 123. Additional smaller openings 133 and 135 can be provided within bezel 125 for camera, microphone or other electronic component access therethrough. Insert 123 is preferably a rigid member such as a prefabricated flat or curved glass sheet or alternately a prefabricated polymeric sheet.

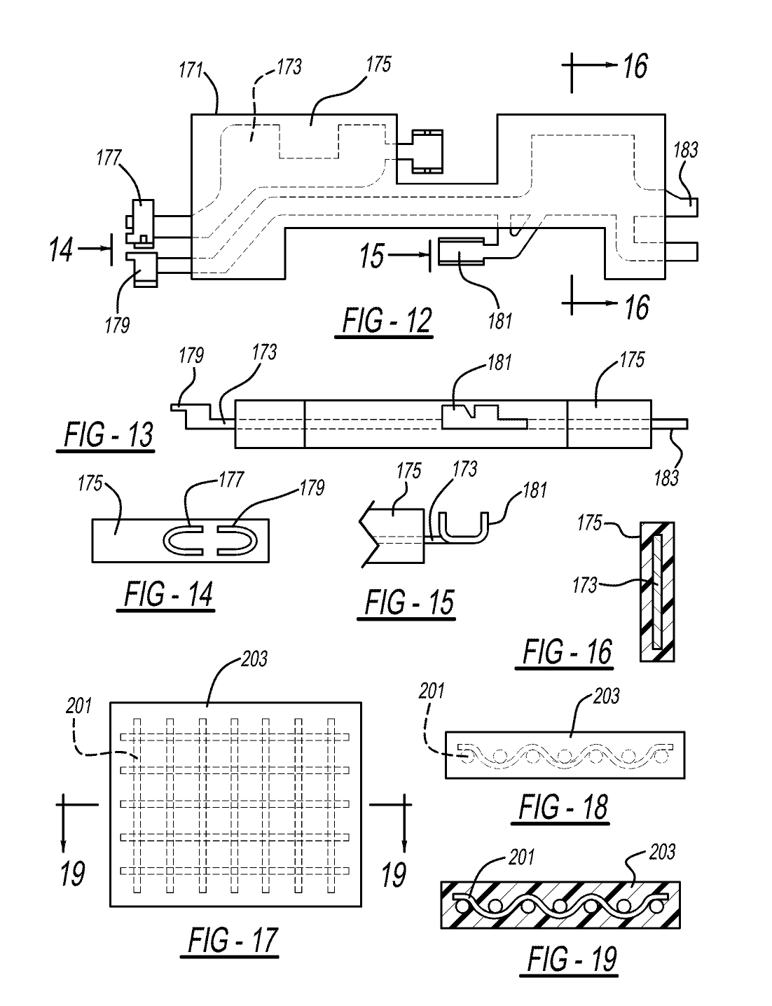

Referring now to FIGS. 12-16, an electrical circuit part 171 includes prefabricated stamped electrical conductors 173 and a three-dimensionally printed polymeric insulator 175 at least partially encapsulating conductors 173. Conductors 173 further include bent electrical connectors 177 which may be of a box 179, U-shaped 181 or flat blade 183 shape extending beyond the printed polymeric insulator 175. This is an ideally suited manufacturing process for manufacturing such a circuit since there are no significant cooling temperature differences during curing of the polymeric insulator 175 verses the inserted conductors 173 as would otherwise occur in a conventional injection molding process which would lead to undesirable sink marks, internal voids and other such part imperfections due to the significant cooling differences and part thickness variations. But this is not a concern for a three-dimensionally printed insert molded part.

Finally, FIGS. 17-19 show a woven fabric or textile insert part 201 entirely or partially encapsulated within a three-dimensionally printed polymeric cover 203. Both the textile insert 201 and polymeric cover 203 can be made of flexible materials to allow for stretching and bending, one can be flexible and the other can be generally rigid, or both may be generally rigid, depending upon the end uses. Alternately, a prefabricated wire mesh or spaced apart elongated fibers can be encapsulated in the printed material.

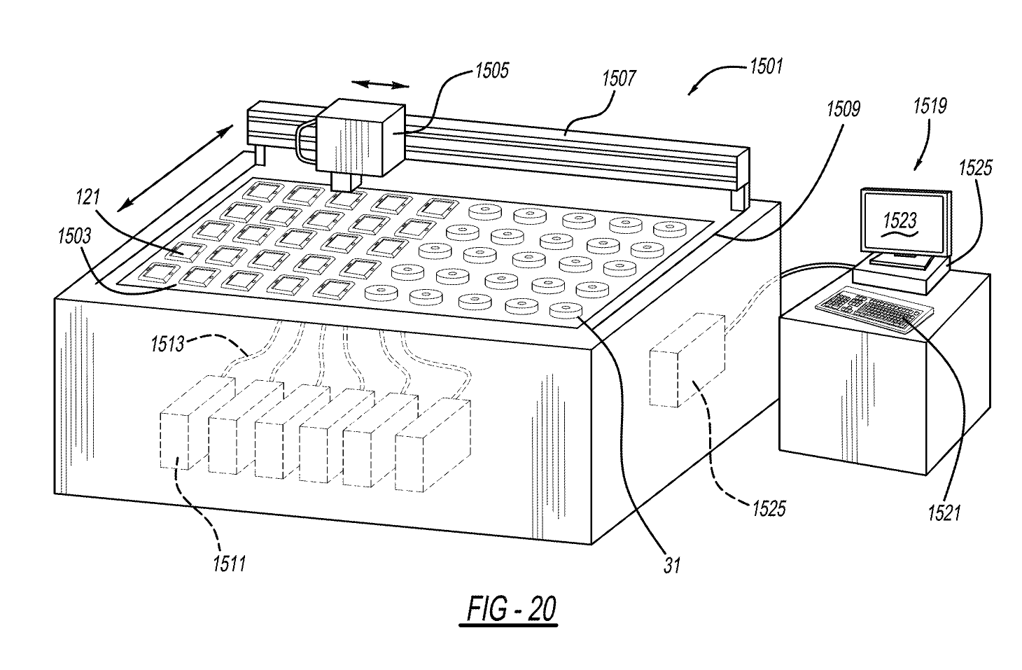

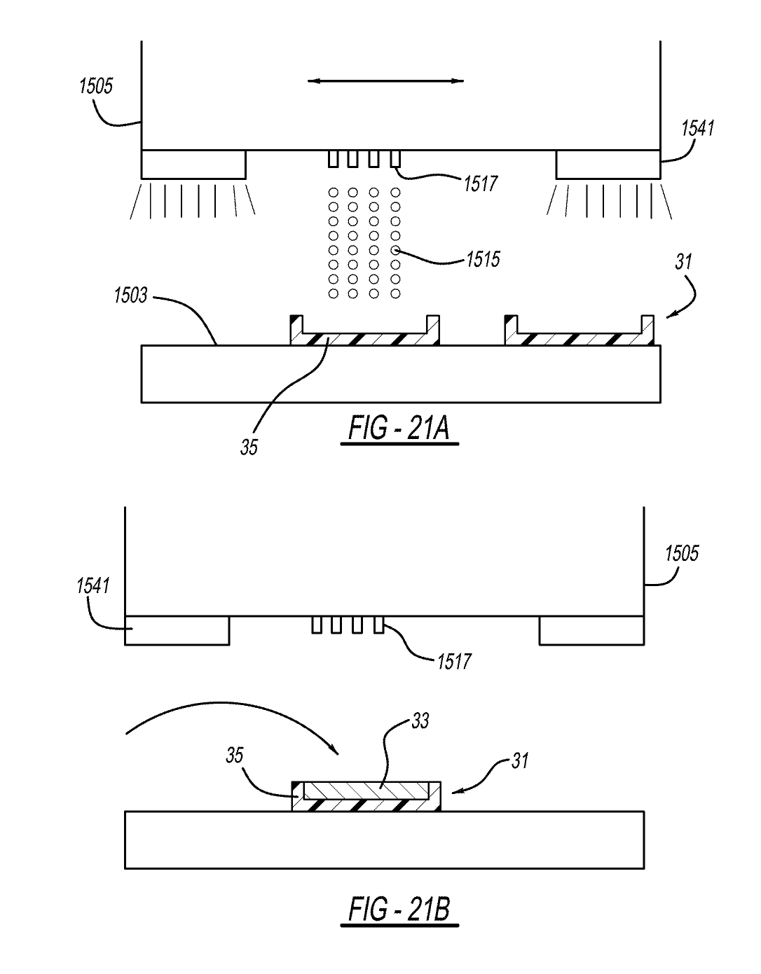

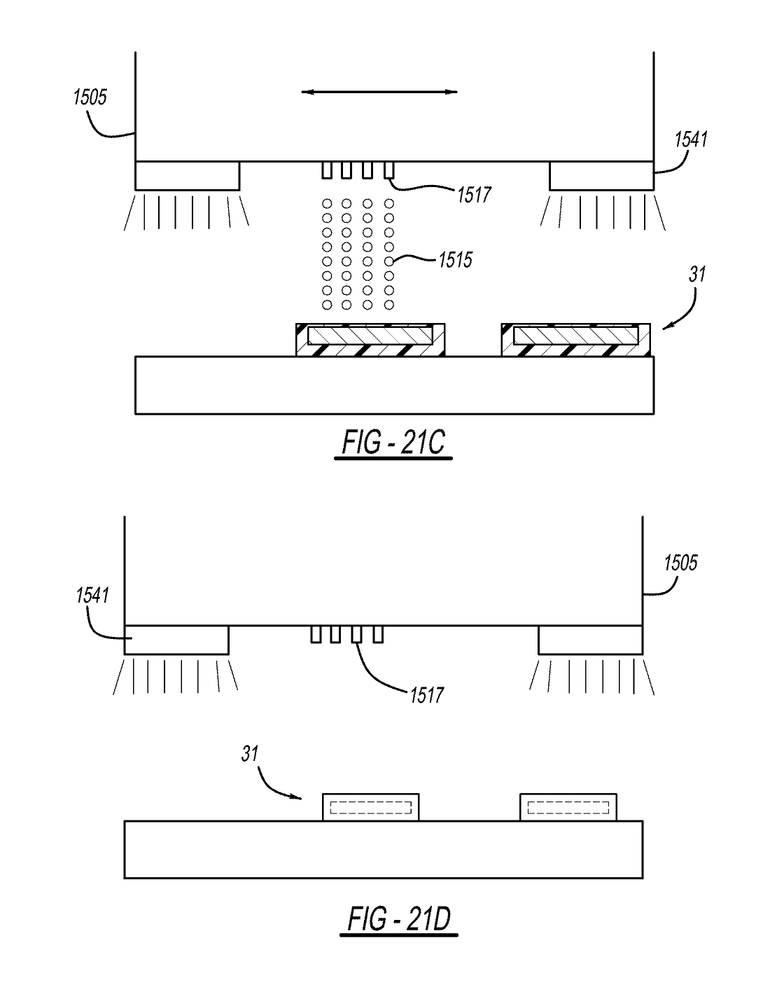

The preferred manufacturing machine and process are shown in FIGS. 20 and 21A-D. A three-dimensional printing machine 1501 includes a support surface 1503 upon which a set of identical parts, for example, washer 31 and bezel/window 121, are created. Machine 1501 further includes at least one ink jet printer head 1505, and preferably eight heads, which traverse side to side along one or more gantry rails 1507 by an electric motor or other automatically controlled actuators. The gantry rail also moves fore and aft above support surface 1503 along outboard tracks 1509, driven by an electric motor or other automatically controlled actuator. At least two storage tanks 1511 or removable cartridges are connected to head 1505 via supply hoses 1513 in order to feed the same or different polymeric materials 1515 contained within each tank 1511 to multiple ink jet printer openings 1517 in head 1505. Openings 1517 may constitute an array of 10×10 or even 100×100 nozzles, and more preferably 96 nozzles, arranged in a linear array such that multiple material flows are simultaneously emitted during a single head pass. The material is preferably an ultraviolet light-curable photopolymer in the form of a powder and water mixture. Alternately, a spool containing an elongated and flexible string or filament of the polymeric material can be fed to the head, melted and emitted onto the support surface as a layered and continuous string.

A computer controller 1519, having an input keyboard 1521, an output display screen 1523, and a microprocessor, is connected to a central processing unit 1525 of machine 1501 to control the feed of material from tanks 1511 and the actuator movement of head 1505 relative to support surface 1503. The machine user downloads a CAD file containing a design of the part into non-transient computer memory, such as RAM, ROM, a hard drive or removeable storage, associated with computer controller 1519. The user then uses software instructions stored in the memory to digitally lay out the desired quantity of the parts onto support surface 1503 and position the parts in a manufacturing orientation, while adding any supports or pixel bridges to the design which are later removed after the manufacturing. The user also inputs the material(s) to be used in the manufacturing, whereafter the microprocessor in computer controller 1519 and CPU 1525 runs the software to cause head 1505 to begin its movement and material deposition in order to create the set of parts.

During the first pass of head 1505, ink jet printing openings 1517 emit streams of polymeric material 1515 and lay down a first layer, constituting a bottom external surface with a first transverse pass of head 1505, for 31. This first pass lays down a material thickness of approximately 0.1-1.0 mm to create a face section of cover 35. As the machine head continues in its transverse path, it will also lay down the same exact material layer for each adjacent part being manufactured in the same manufacturing cycle. One or more ultraviolet lights 1541 are attached to head 1505 which serve to emit light onto the layered material immediately after its deposition which binds together and cures the layer of material deposited. After the first layer has been deposited for each of the multiple parts, head 1505 then emits a second layer of polymeric material 1515 upon the already deposited first layer which is then bound to the first layer when cured by lights 1541. This layering and curing is repeated many times, until it reaches the condition shown in FIG. 21A. The head is then stopped and an operator (or automated robot) removes built up supporting materials and then places insert 33 onto the built up polymeric face surface in the partly produced cavity therein. The machine is subsequently reactivated as shown in FIG. 21C, to additively create additional printed polymeric layers thereon, for example, with more than fifty layers or head passes, until the part is fully created and light cured. The insert is integrally bonded to the printed polymer so the final cured part is a single piece. Optionally, the insert can be adhesively coated in the areas to receive the printed polymer. For some versions such as with the nut embodiment, removable supports may create a location within which the insert is later inserted, after removal of the supports, and the further additive print layering is thereafter performed.

Material is deposited where computer controller 219 informs head that a wall or other polymeric formation is desired but head will print a removable (e.g., dissolvable) support material where a bore or other open area is present in the CAD drawing of the part. The polymeric material is stacked in many layers thereby creating the entire part as an integral and single piece part in an ambient and non-pressurized gaseous, particularly air, environment inside an enclosure of machine 1501. In other words, the parts are all surrounded by air except for the first layer which contacts support surface 1503, during the entire manufacturing cycle. As used herein, manufacturing or machine “cycle” refers to the time period from which the head begins depositing the first layer of material until when the head deposits the final layer of material for the completed part and is cured in the machine. After the machine cycle is complete, the user manually removes the manufactured parts from support surface 1503, such as by use of a putty knife or other removal tool. At least forty parts are made in a single machine cycle, which is preferably less than ninety minutes. In one optional step, a jet or stream of high pressure water fluid is applied to each removed part which serves to dissolve any supports or bridges since they are made of a dissolvable material, different from the primary material defining walls of the part. Otherwise, the parts are removed from the printing machine in a fully cured state with no additional post-processing required.

Exemplary generic three-dimensional printing machines and materials that can be employed to make the parts as specified herein are disclosed in U.S. Patent Publication Nos. 2010/0217429 entitled “Rapid Production Apparatus” which published to Kritchman et al. on Aug. 26, 2010, 2011/0074065 entitled “Ribbon Liquefier for Use in Extrusion-Based Digital Manufacturing Systems” which published to Batchelder et al. on Mar. 31, 2011, and U.S. Pat. No. 7,851,122 entitled “Compositions and Methods for Use in Three Dimensional Model Printing” which issued to Napadensky on Dec. 14, 2010, U.S. Pat. No. 7,369,915 entitled “Device, System and Method for Accurate Printing of Three Dimensional Objects” which issued to Kritchman et al. on May 6, 2008, and U.S. Pat. No. 5,866,058 entitled “Method for Rapid Prototyping of Solid Models” which issued to Batchelder et al. on Feb. 2, 1999. These patent publications and patents are all incorporated by reference herein. A presently preferred machine is the Connex 500 model from Objet Geometries Inc. Nevertheless, it should be appreciated that manufacturing the parts disclosed herein by the present three-dimensional printing steps also disclosed herein is a significant leap in technology.

While various embodiments have been disclosed herein, and it should be appreciated that other variations may be employed. For example, predetermined and entirely enclosed hollow spaces can be designed and manufactured inside thickened walls of any of the present parts in order to save material costs and weight. Furthermore, it is envisioned that other insert shapes or materials, such as an engineering grade of polymer, for example, injection molded nylon, can be used as the prefabricated insert placed into the three-dimensional printing machine and becoming integrally one-piece with the finished component part. Any of the part functions, features and segments thereof may be interchanged with any of the other parts disclosed hereinabove, although certain benefits may not be realized. Nevertheless, such changes, modifications or variations are not to be regarded as a departure from the spirit and scope of the present invention.

1. A method of making a part comprising the steps of:
creating a first layer of polymeric material in a three-dimensional printing machine;
emitting light onto the first layer after the prior step to cure, harden or bond the layer;
creating at least a second layer of the polymeric material upon the first layer after the prior step;
emitting light onto the second layer after the prior step to cure, harden or bond the second layer;
forming a cavity in said second layers without the use of a space-defining structure;
placing a prefabricated insert into said cavity
causing the insert to be attached to at least one of the polymeric material layers in the three-dimensional printing machine; and
removing the finished part from the three-dimensional printing machine
wherein said part is integrally bonded to the printed part thus generating a single piece.

2. The method of claim 1, further comprising depositing the first layer of the material from a printing head onto a support surface of the machine in an ambient and unpressurized aft environment.

3. The method of claim 2, wherein the polymeric material is flexible after being removed from the machine.

4. The method of claim 1, wherein the prefabricated insert is metallic.

5. The method of claim 1, wherein the insert is entirely encapsulated within the printed polymeric material.

6. The method of claim 1, wherein the light is ultraviolet light which is immediately passed over each layer of the part after it is deposited.

7. The method of claim 1, further comprising making the part as a washer, having a central hole and a circular periphery, from the insert and polymeric layers.

8. The method of claim 1, further comprising making the part as a push-on cap, having a concave center and peripheral flange, from the insert and polymeric layers.

9. The method of claim 1, wherein a polymeric portion of the part is more flexible than the insert which is more rigid.

10. The method of claim 1, further comprising making the part as an internally threaded nut from the insert and polymeric layers.

11. The method of claim 1, wherein the insert is a transparent sheet and the polymeric layers create a bezel adjacent edges of the sheet.

12. The method of claim 1, wherein the insert is an electrical conductor and the polymeric layers create an insulator.

13. The method of claim 1, wherein the insert is a textile sheet.

14. A method of making a part comprising the steps of:
depositing a layer of polymeric material onto the support surface of a printing machine;
depositing subsequent layers of the material upon each prior layer to define a cavity without the use of a space-defining structure;
placing an insert into said cavity;
depositing at least an additional layer of the material to encapsulate said insert;
curing the part so that the layers of the polymeric material bond together and at least one of the polymeric material layers bonds to the insert; and
removing the completed part, including the polymeric material and insert as a single piece.

15. (canceled)

16. The method of claim 14, further comprising flowing the material from a machine head positioned above the support surface, at least one of the machine head and the support surface automatically moving relative to the other according to computer instructions in order to create identical multiples of the part in the same machine cycle, free of contraction or expansion due to the manufacture thereof.

17. The method of claim 14, wherein the material is a three-dimensionally printable polymer.

18. (canceled)

19. The method of claim 14, further comprising flowing the polymeric material from an ink jet printing head including openings arranged in an array such that multiple material flows are simultaneously occurring for each layer of the part.

20. (canceled)

21. (canceled)

22. (canceled)

23. (canceled)

24. A part comprising:
a first section of the part including at least one three-dimensionally printable material, said first section having at least one void formed therein without a space-defining structure;
a second section of the part including an insert made from one of: metal, polymer, glass or fabric; and
the sections being integrally attached together to define the part, said part being encapsulated by said printable material.

25. The part of claim 24, wherein the three-dimensionally printable material includes a polymeric material.

26. The part of claim 24, wherein the insert is selected from the group consisting of a metal, glass and fabric.

27. (canceled)

28. (canceled)

29. The part of claim 24, wherein the insert is polymeric of a different material from the first section.

30. The part of claim 24, wherein the three-dimensionally printable material is light curable.

31. The part of claim 24, wherein one of the sections is threaded.

32. The method of claim 1, wherein the insert is partially encapsulated within the printed polymeric material.

33. The method of claim 1, including the step of forming a void during the layering process.

34. The method of claim 1, including the step of forming a hollow space in at least one layer of polymeric material.

35. The method of claim 1, including the step of apply in an adhesive coating on said insert before the step of causing the insert to be attached.

36. The method of claim 1, wherein no significant cooling temperature differences exist during the curing of the polymeric material, thus preventing sink marks and internal voids.

37. The part of claim 24, wherein said part is partially or entirely encapsulated by said printable material.
